(19) United States
(12) Patent Application Publication
(10) Pub. No.: US 2020/0397005 A1
(43) Pub. Date: Dec. 24, 2020

(54) NONTOXIC INSECT REPELLANT

(71) Applicant: Albert Alston, Bloomfield, NJ (US)

(72) Inventor: Albert Alston, Bloomfield, NJ (US)

(21) Appl. No.: 16/444,738

(22) Filed: Jun. 18, 2019

(51) Int. Cl. A01N 65/22

(52) U.S. Cl. CPC A01N 65/22

(57) ABSTRACT

A composition that repels insects or arthropods including a combination of nepeta-cataria oil, a mint oil, and a carrier.

### BACKGROUND OF THE INVENTION

The present invention relates to insect repellants and, more particularly, to nontoxic insect repellants.

An insect repellent is a substance applied to skin, clothing, or other surfaces which discourages insects from landing or climbing on that surface. Insect repellents help prevent and control the outbreak of insect-borne diseases such as malaria, Lyme disease, dengue fever, bubonic plague, river blindness, and West Nile fever.

At the present time, N,N,-diethyl-m-toluamide (DEET) is the active ingredient of most commercial topical insect repellents. The major commercial brands are all DEET based products. Consumer Reports tests indicated that products with the highest concentration of DEET lasted the longest against mosquitoes but cautioned that excessive use of DEET could pose some risk, especially for children.

As can be seen, there is a need for an effective and long-lasting nontoxic insect repellants.

### SUMMARY OF THE INVENTION

In one aspect of the present invention, a composition that repels insects or arthropods comprises a combination of nepeta-cataria oil, a mint oil, and a carrier.

In another aspect of the present invention, a method of repelling insects, the method comprises: obtaining an insect repellant composition comprising: a carrier, and active ingredients comprising a combination of nepeta-cataria oil and a mint oil; and applying the insect repellant composition to at least one of a human, an animal, and a structure to repel insects.

These and other features, aspects and advantages of the present invention will become better understood with reference to the following drawings, description and claims.

### BRIEF DESCRIPTION OF THE DRAWINGS

FIG. 1 is a flowchart illustrating the uses of an embodiment of the present invention; and

FIG. 2 is a flowchart illustrating the combination of ingredients of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention may include a non-toxic pest management for outdoor, indoor, recreational, gardening, and agricultural environments. The present invention functions as a topical insect repellant for sports, recreation, and leisure activities. The present invention may include a spray used for structures, which may be referred to as “Clear the Deck.” The present invention may also include a spray or topical cream used for personal care, such as on a human or animal, which may be referred to as “Bug Nip.”

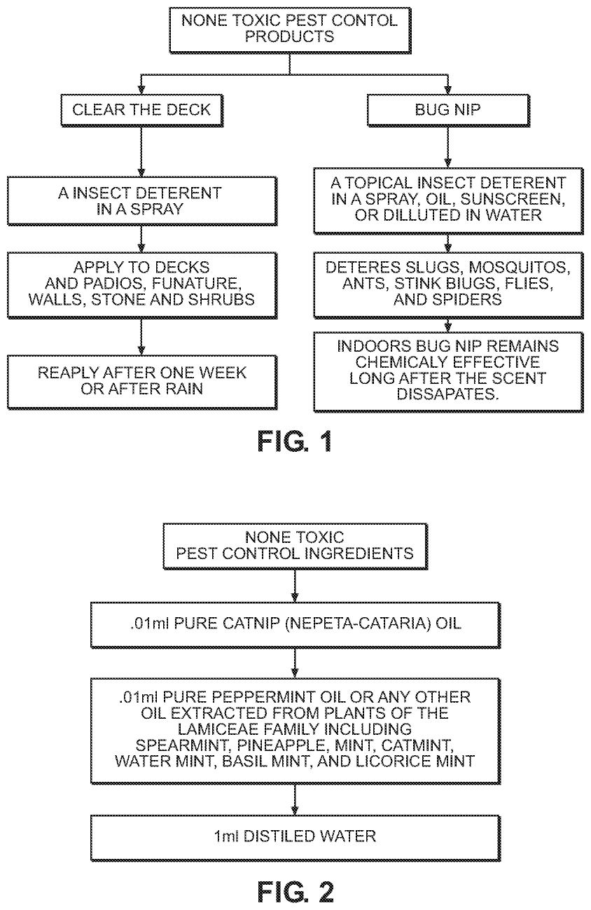

Referring to FIGS. 1 and 2, the present invention includes a composition that repels insects or arthropods comprising a combination of nepeta-cataria oil, a mint oil, and a carrier. The composition is biodegradable.

The nepeta-cataria oil is oil that is extracted from nepeta-cataria, commonly known as catnip. The mint oil is oil extracted from mint plants. The mint oil may include peppermint, spearmint, pineapple mint, catmint, chocolate mint, orange mint, lavender mint, calamint, water mint, basil mint, licorice mint, or a combination thereof.

The carrier may be a dermatologically acceptable-carrier. The carrier allows the formulation to be adjusted to an effective concentration of repellant molecules. The carrier may further prevent skin irritation, and/or soothe and condition skin. For example, the carrier of the present invention may include water, a topical cream, or the like. If the carrier is a water, the composition may used with a spray bottle and may be sprayed on a target as a mist. Alternatively, the composition may be part of a topical cream which may be applied to a user's skin.

The present invention may further include a method of repelling insects. The method includes obtaining an insect repellant composition including a carrier, and active ingredients including a combination of nepeta-cataria oil and a mint oil. The method further includes applying the insect repellant composition to at least one of a human, an animal, and a structure to repel insects.

The combination comprises about 0.001 ml up to about 0.02 ml of the nepeta-cataria oil, about 0.001 ml up to about 0.02 ml of the mint oil, and about 1 ml of the carrier, such as 1 ml of water. For example, the combination may include concentration levels of about 0.01 ml of the nepeta-cataria oil, about 0.01 ml of the mint oil, and about 1 ml of the carrier.

As mentioned above, the present invention may be formulated into an outdoor use and a personal use. The outdoor use, Clear the Deck, may include a spray form insect deterrent that lasts for about a week. The composition may be applied to outdoor furniture, deck work, walls, stone, and shrubs in the event of rain. Back yard, deck, and patio areas benefit most from this form of management tool.

Bug Nip may be used for personal use. Bug Nip may include a topical insect deterrent which is applied as a spray or in concentrated form where users may dilute it in water, oil, creams, or sun screen as needed, granting the user the autonomy of adjustable personal care. This feature enables users to use Bug Nip in a diverse array of activities. Bug Nip may also be used as a pest deterrent in gardening and agriculture. Evidence of effectiveness has been observed in the deterrence of slugs, mosquitoes, ants, stink bugs, flies, and spiders.

A unique feature of Bug Nip during indoor use is that its chemical effectiveness remains long after its scent is gone, creating an odorless, non-toxic, pest resistant barrier. In higher concentrations Bug Nip may be used as a pesticide for some insects.

It should be understood, of course, that the foregoing relates to exemplary embodiments of the invention and that modifications may be made without departing from the spirit and scope of the invention as set forth in the following claims.

What is claimed is:

1. A composition that repels insects or arthropods comprising a combination of nepeta-cataria oil, a mint oil, and a carrier.

2. The composition of claim 1, wherein the combination comprises concentration levels of about 0.01 ml of the nepeta-cataria oil, about 0.01 ml of the mint oil, and about 1 ml of the carrier.

3. The composition of claim 1, wherein the mint oil is selected from the group consisting of peppermint, spearmint, pineapple mint, catmint, chocolate mint, orange mint, lavender mint, calamint, water mint, basil mint, and licorice mint.

4. The composition of claim 1, wherein the carrier is at least one of a topical cream and water.

5. The composition of claim 1, wherein the carrier is water and the composition is delivered as a spray.

6. A method of repelling insects, the method comprising:
obtaining an insect repellant composition comprising:
a carrier, and
active ingredients comprising a combination of nepeta-cataria oil and a mint oil; and
applying the insect repellant composition to at least one of a human, an animal, and a structure to repel insects.

7. The method of claim 6, wherein the carrier is at least one of water and a topical cream.

8. The method of claim 6, wherein the carrier is water and the composition is delivered as a spray.

9. The method of claim 6, wherein the combination comprises concentration of about 0.01 ml of the nepeta-cataria oil, about 0.01 ml of the mint oil, and about 1 ml of the carrier.

10. The method of claim 6, wherein the mint oil is selected from the group consisting of peppermint, spearmint, pineapple mint, catmint, chocolate mint, orange mint, lavender mint, calamint, water mint, basil mint, and licorice mint.
